(19) United States
(12) Patent Application Publication
(10) Pub. No.: US 2011/0014927 A1
(43) Pub. Date: Jan. 20, 2011

(54) METHOD AND MOBILE ELECTRONIC DEVICE FOR A FUNCTION OF GIVING NOTICE ACCORDING TO POSITIONS

(75) Inventors: Chen WANG, SHANGHAI CITY (CN); Li YU, SHANGHAI CITY (CN); Shih-Kuang TSAI, SHANGHAI CITY (CN)

Correspondence Address: BRIAN M. MCINNIS, 12th Floor, Ruttonjee House, 11 Duddell Street, Hong Kong, HK

(73) Assignee: INVENTEC APPLIANCES CORP., TAIPEI HSIEN (TW)

(21) Appl. No.: 12/837,501

(22) Filed: Jul. 16, 2010

(30) Foreign Application Priority Data
Jul. 16, 2009 (TW) 98124111

(51) Int. Cl. H04W 24/00

(52) U.S. Cl. 455/456.1

(57) ABSTRACT

A method for performing a function of giving notice according to positions are provided, which enables performing a function of giving notice by not only setting a predetermined time but setting a predetermined position. The function s of giving notice is performed when the predetermined time is up or reached, or when the positioning unit of the mobile electronic device detects that a user reaches a point within a predetermined accuracy range of the predetermined position. This disclosure performs the function of giving notice by combining both ways of determining if the predetermined time is up or reached and if a io user reaches a point within the predetermined accuracy range of the predetermined position to overcome the disadvantages generated by only setting the predetermined time. Therefore, the disclosure provides more flexible ways for a user when taking positions as the first priority not a particular time point.

### RELATED APPLICATIONS

This application claims priority to Taiwan Application Serial Number 98124111, filed Jul. 16, 2009, which is herein incorporated by reference.

### BACKGROUND

1. Field of Invention

The present invention relates generally to a method and a mobile electronic device for activating an event prompt and, more particularly, to a method and a mobile electronic device for performing corresponding function of giving notice according to different positions by way of positioning.

2. Description of Related Art

Generally speaking, people use calendars to record their schedules. A calendar and an alarm clock are essential functions in a mobile electronic device such as a mobile phone. The calendar and the alarm clock activate a prompt of a predetermined event according to a predetermined time setting set by a user. The predetermined time setting can be set at a particular time in the present day or a fixed time in one or several days of a week, namely a periodic alarm clock, and the schedule and the event recorded in the calendar of the mobile electronic device can be set at a particular time of some day. In other words, one of the event prompts in conventional calendars is to remind a user of the predetermined schedules or the predetermined event information he should deal with before the predetermined time setting is up.

Nevertheless, many events usually have no particular time for a user to set in particular conditions such as a condition that a user needs to finish one or several events in a period of time but not by a particular time point, and further more some locations in which a user transacts events are probably the places to which the user usually goes or the places and their vicinity by which the user is going to pass. Therefore, it is more convenient to set the calendar and the alarm clock according to the predetermined position than according to the predetermined time setting.

### SUMMARY

The present invention provides a method for performing a function, of a mobile electronic device, of giving notice according to a position of the mobile electronic device by a mobile electronic device having a Global Positioning System (GPS) to perform flexible application.

Thus, in one aspect, the present invention provides a method for performing a function, of a mobile electronic device, of giving notice according to position, and the method is performed with a mobile electronic device comprising a control unit, an input unit, a storage unit, and a positioning unit. The method comprises the steps of inputting information of a predetermined position, a predetermined accuracy range, and a predetermined time by using the input unit, and storing the information of the predetermined position, the predetermined accuracy range, and the predetermined time in the storage unit; using the positioning unit to obtain information of a present position and a present time of the mobile electronic device; using the control unit to calculate a distance between the present position and the predetermined position; using the control unit to determine if the distance is within the predetermined accuracy range; and if it's determined that the distance is within the predetermined accuracy range, performing the function of giving notice.

In another aspect, the present invention provides a mobile electronic device having a function of giving notice according to a position of the mobile electronic device comprising an input unit for inputting information of a predetermined position, a predetermined accuracy range, and a predetermined io time; a storage unit for storing the information of the predetermined position, the predetermined accuracy range, and the predetermined time; a positioning unit for obtaining information of a present position and a present time of the mobile electronic device; and a control unit for calculating a distance between the present position and the predetermined position, and determining if the distance is within the predetermined accuracy range; wherein if it's determined that the distance is within the predetermined accuracy range, the mobile electronic device performs the function of giving notice.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 shows schematically a block diagram of a mobile electronic device according to one embodiment of the present invention.

FIG. 2 shows schematically a flow diagram of a method for performing a function, of a mobile electronic device, of giving notice based on a position of io the mobile electronic device according to one embodiment of the present invention.

FIG. 3 shows schematically a flow diagram of a method for performing a function, of a mobile electronic device, of giving notice based on a position of the mobile electronic device according to another embodiment of the present invention.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

As used herein, “around”, “about” or “approximately” shall generally mean within 20 percent, preferably within 10 percent, and more preferably within 5 percent of a given value or range. Numerical quantities given herein is are approximate, meaning that the term “around”, “about” or “approximately” can be inferred if not expressly stated.

As used herein, the terms “comprising,” “including,” “having,” “containing,” “involving,” and the like are to be understood to be open-ended, i.e., to mean including but not limited to.

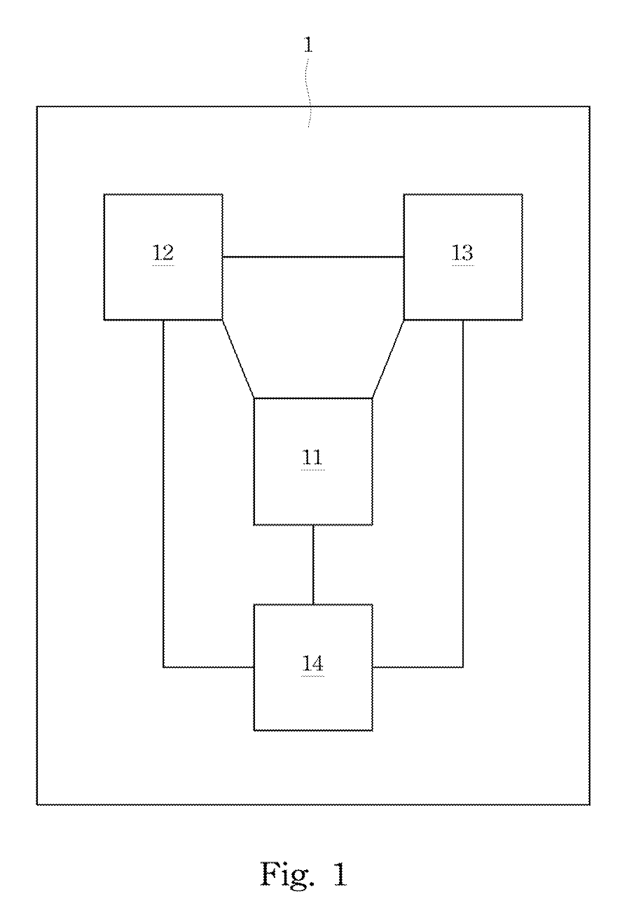

FIG. 1 shows schematically a block diagram of a mobile electronic device according to one embodiment of the present invention. The mobile electronic device 1 of this disclosure is a mobile phone or a personal digital assistant (PDA). The mobile electronic device 1 comprises a control unit 11, an input unit 12, a storage unit 13, and a positioning unit 14, wherein the positioning unit 14 is a global positioning system (GPS) but not limited thereto.

The input unit 12 of the mobile electronic device 1 is used to input information of a predetermined position, a predetermined accuracy range, and a predetermined time: The predetermined position is a place name or latitude and longitude information, and the predetermined accuracy range is, for example, 1000 meters, 500 meters, 100 meters, and so on. Generally, the accuracy of the GPS is substantially 5 meters in theory while that of the GPS is about 10 meters when a user uses it in the city. An appropriate value of a minimum accuracy range (for example, 50 meters) can be selected from the accuracy ranges set inside the positioning unit 14, and a user can select a value that is o not less than the minimum accuracy range. The input unit 12 can be a keyboard, a touch panel, or the combination of both the keyboard and the touch panel.

In addition, the storage unit 13 can store the information of the predetermined position, the predetermined accuracy range, and the predetermined time, and the positioning unit 14 can obtaining information of a is present position and a present time of the mobile electronic device 1. The information of the present position relates to latitude and longitude of the present position, or relates to movement speed, direction or angle of the mobile electronic device. The control unit 11 can calculate a distance between the present position and the predetermined position and perform the function of giving notice of, for example, a scheduled piece of work, if the distance is within the predetermined accuracy range. The function of giving notice can be performed with bell sound (hearing), flash (vision), and shake (sense of touch), and the mobile electronic device 1 can display the predetermined schedule and the predetermined event information, but not limited thereto.

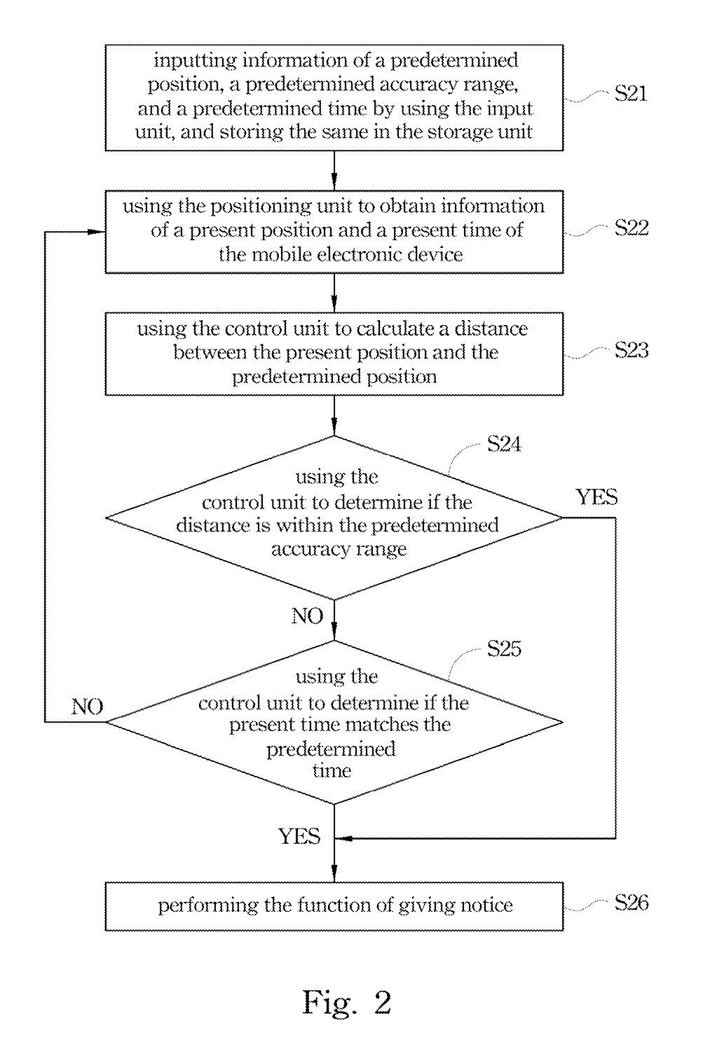

FIG. 2 shows schematically a flow diagram of a method for performing a function, of a mobile electronic device, of giving notice based on position of the mobile electronic device according to one embodiment of the present invention. The method performed with a mobile electronic device comprises the steps of:

Step S21: inputting information of a predetermined position, a predetermined accuracy range, and a predetermined time by using the input unit 12, and storing the information of the predetermined position, the predetermined accuracy range, and the predetermined time in the storage unit 13;

Step S22: using the positioning unit 14 to obtain information of a present position and a present time of the mobile electronic device;

Step S23: using the control unit 11 to calculate a distance between the present position and the predetermined position;

Step S24: using the control unit 11 to determine if the distance is within the predetermined accuracy range, and performing Step S26 if it's determined that the distance is within the predetermined accuracy range;

Step S25: using the control unit 11 to determine if the present time matches the predetermined time if it's determined that.the distance is not within the predetermined accuracy range, and performing Step S26 if it's determined that the present time matches the predetermined time, and going back to Step S22 if it's determined that the present time does not match the predetermined time; and

Step S26: performing the function of giving notice.

That is to say, a user can not only set the predetermined time, but set the predetermined position for performing the function of giving notice when the user arranges a schedule with the use of the positioning unit 14 (for example, GPS) disposed inside the mobile electronic device 1 for obtaining information of the present position (Step S22). In the present embodiment, the event prompt according to the predetermined position will be the priority if the user reaches somewhere around the predetermined position before the predetermined time is up or reached so that the mobile electronic device 1 provides address resolution service to inquire and obtain latitude and longitude information by using the web o mapping application, for example, Google Maps or PAPAGO, and stores the latitude and longitude information in the scheduling information of the event. Google Maps is a web mapping service application and technology provided by Google, and PAPAGO is satellite navigation software provided by Maction Technologies, Inc.

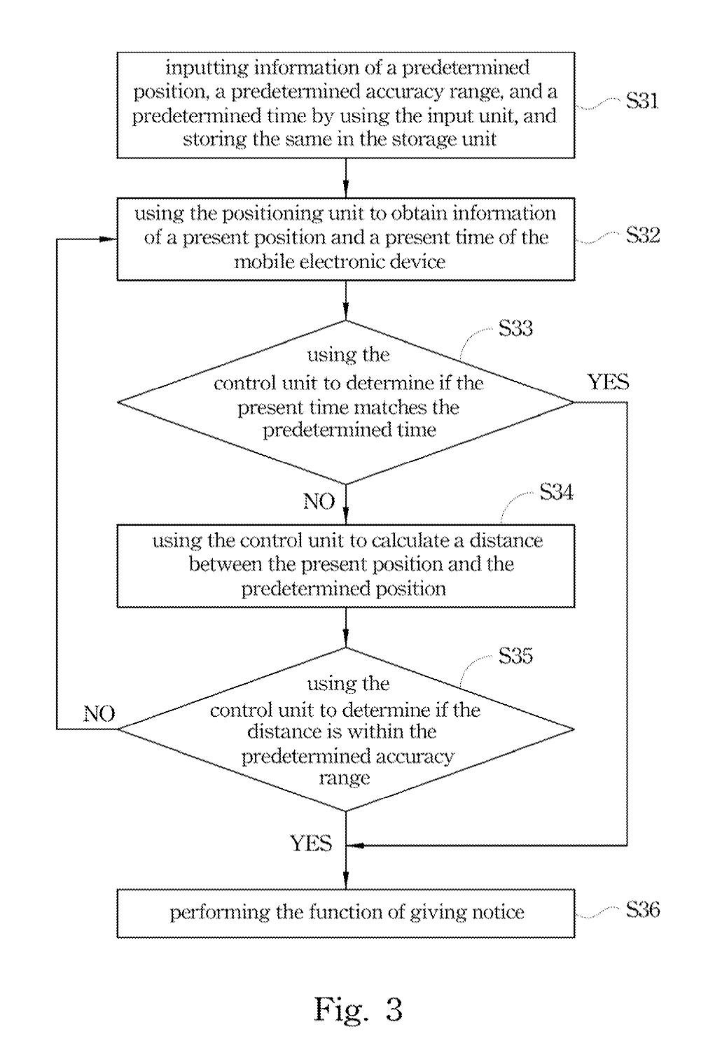

FIG. 3 shows schematically a flow diagram of a method for performing a function, of a mobile electronic device, of giving notice based on a position of the mobile electronic device according to another embodiment of the present invention. The method performed with the mobile electronic device 1 comprises the steps of:

Step S31: inputting information of a predetermined position, a predetermined accuracy range, and a predetermined time by using the input unit 12, and storing the information of the predetermined position, the predetermined accuracy range, and the predetermined time in the storage unit 13;

Step S32: using the positioning unit 14 to obtain information of a present position and a present time of the mobile electronic device;

Step S33: using the control unit 11 to determine if the present time matches the predetermined time, and performing Step S36 if it's determined that the present time matches the predetermined time,

Step S34: using the control unit 11 to calculate a distance between the present position and the predetermined position if it's determined that the present time doesn't match the predetermined time,

Step S35: using the control unit 11 to determine if the distance is within lo the predetermined accuracy range, and performing Step S36 if it's determined that the distance is within the predetermined accuracy range;, and going back to Step S32 if it's determined that the distance is not within the predetermined accuracy range, and

Step S36: performing the function of giving notice.

That is to say, a user can not only set the predetermined time, but set the predetermined position for performing a function of giving notice when the user arranges a schedule with the use of the positioning unit 14 (for example, GPS) disposed inside the mobile electronic device 1 for obtaining the information of the present position (Step S32). In the embodiment, the predetermined time will. be the priority if the predetermined time setting is up or reached before the user reaches somewhere around the predetermined position.

As a result, with the use of the mobile electronic device 1 and the method for perfoeming the function of giving notice according to locations and GPS extensively applied inside mobile electronic devices, the mobile electronic device 1 can use bell sound (hearing), flash (vision), and shake (sense of touch) to remind the user and display the predetermined schedule and the predetermined event information when the predetermined time is up or reached or a user and/or the mobile electronic device 1 reaches a point within the predetermined accuracy range of the predetermined position so that the disclosure can perform flexible application.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for performing a function, of a mobile electronic device, of giving notice according to a position of the mobile electronic device, the mobile electronic device comprising a control unit, an input unit, a storage unit, and a positioning unit, and the method comprising:
inputting information of a predetermined position, a predetermined accuracy range, and a predetermined time by using the input unit, and storing the information of the predetermined position, the predetermined accuracy range, and the predetermined time in the storage unit;
using the positioning unit to obtain information of a present position and a present time of the mobile electronic device;
using the control unit to calculate a distance between the present position and the predetermined position;
using the control unit to determine if the distance is within the predetermined accuracy range; and
if it's determined that the distance is within the predetermined accuracy range, performing the function of giving notice.

2. The method according to claim 1, wherein if it's determined that the distance is not within the predetermined accuracy range, the method further comprises:
using the control unit to determine if the present time matches the predetermined time; and
if it's determined that the present time matches the predetermined time, performing the function of giving notice.

3. The method according to claim 2, wherein if it's determined that the present time does not match the predetermined time, the method proceeds to the step of using the positioning unit to obtain information of a present position and a present time of the mobile electronic device.

4. The method according to claim 1, wherein before the step of using the control unit to determine if the distance is within the predetermined accuracy range, the method further comprises:
using the control unit to determine if the present time matches the predetermined time; and
if it's determined that the present time matches the predetermined time, performing the function of giving notice;
wherein the step of using the control unit to determine if the distance is within the predetermined accuracy range is performed if it's determined that the present time does not match the predetermined time.

5. The method according to claim 1, wherein the information of the predetermined position is about a place name or latitude and longitude of the predetermined position.

6. The method according to claim 1, wherein the predetermined accuracy range is substantially five meters or fifty meters.

7. The method according to claim 1, wherein the information of the present position relates to latitude and longitude of the present position, or relates to movement speed, direction or angle of the mobile electronic device.

8. The method according to claim 1, wherein the positioning unit is a Global Positioning System (GPS) device.

9. The method according to claim 1, wherein the information of the predetermined position and the information of the present position are provided by a web mapping application.

10. A mobile electronic device having a function of giving notice according to a position of the mobile electronic device, comprising:
an input unit for inputting information of a predetermined position, a predetermined accuracy range, and a predetermined time;
a storage unit for storing the information of the predetermined position, the predetermined accuracy range, and the predetermined time;
apositioning unit for obtaining information of a present position and a present time of the mobile electronic device; and
a control unit for calculating a distance between the present position and the predetermined position, and determining if the distance is within the predetermined accuracy range;
wherein if it's determined that the distance is within the predetermined accuracy range, the mobile electronic device performs the function of giving notice.

11. The mobile electronic device according to claim 10, wherein if it's determined that the distance is not within the predetermined accuracy range, the control unit is further used to determine if the present time matches the predetermined time; and if it's determined that the present time matches the predetermined time, the mobile electronic device performs the function of giving notice.

12. The mobile electronic device according to claim 11, wherein the positioning unit is used to obtain information of a present position and a present time of the mobile electronic device, if it's determined that the present time does not match the predetermined time.

13. The mobile electronic device according to claim 10, wherein the control unit is used to determine if the present time matches the predetermined time; if it's determined that the present time matches the predetermined time, the mobile electronic device performs the function of giving notice; and the control unit is used to determine if the distance is within the predetermined accuracy range, if it's determined that the present time does not match the i predetermined time.

14. The mobile electronic device according to claim 10, wherein the information of the predetermined position is about a place name or latitude and longitude of the predetermined position.

15. The mobile electronic device according to claim 10, wherein the predetermined accuracy range is substantially five meters or fifty meters.

16. The mobile electronic device according to claim 10, wherein the information of the present position relates to latitude and longitude of the o present position, or relates to movement speed, direction or angle of the mobile electronic device.

17. The mobile electronic device according to claim 10, wherein the positioning unit is a GPS device.

18. The mobile electronic device according to claim 10, wherein the information of the predetermined position and the information of the present position are provided by a web mapping application.

19. The mobile electronic device according to claim 18, wherein the web mapping application is Google Maps or PAPAGO.

20. The mobile electronic device according to claim 10, wherein the mobile electronic device is a mobile phone or a personal digital assistant.
